(19) United States
(12) Patent Application Publication
(10) Pub. No.: US 2019/0066903 A1
(43) Pub. Date: Feb. 28, 2019

(54) SEGMENTED CORE SYSTEM FOR TOROIDAL TRANSFORMERS

(71) Applicant: Madison Daily, Rolla, MO (US)

(72) Inventor: Madison Daily, Rolla, MO (US)

(21) Appl. No.: 15/692,268

(22) Filed: Aug. 31, 2017

(51) Int. Cl. H01F 27/26; H01F 30/16; H01F 27/32; H01F 27/25; H01F 27/30; H01F 41/08

(52) U.S. Cl. CPC H01F 27/266; H01F 30/16; H01F 41/08; H01F 27/25; H01F 27/306; H01F 27/325

(57) ABSTRACT

A modular toroidal transformer core assembly, including a plurality of interconnected semicircular core segments defining an annular core. Each respective semicircular core segment further includes a plurality of curved steel layers defining a semicircular core segment having a first end and a second end with a plurality of fingers extending from each end and a plurality of gaps extending from each end, wherein each respective gap lies between and is defined between two respective fingers. Each respective finger defines a predetermined number of layers. An aperture extends through each end of the respective semicircular core segments, with a fastener extending through each respective aperture to hold each respective semicircular core segment together. Each respective semicircular core segments is interlockingly engaged with another respective semicircular core segment to define the annular core.

### TECHNICAL FIELD

The present novel technology relates generally to toroidal transformer systems, and, more particularly, to a segmented core for use with toroidal transformer cores and a method for using the same.

### BACKGROUND

A transformer is an electrical device that transfers energy between two or more circuits through the phenomenon of electromagnetic induction. Transformers are commonly used to increase (step-up) or decrease (step-down) the voltages of alternating current in electric power applications. This is accomplished by passing a varying current through the primary winding to generate a magnetic flux in the transformer's core. This flux then induces a voltage in the transformer's secondary winding. Depending on the ratio of the primary windings to the secondary windings, the transformers output voltage can be increased or decreased.

For most transformers designed for small-scale use, such as in devices commonly used in homes or offices, one of two styles of transformers is typically used. These are transformers with either an E-I laminate or a toroidal core (See FIG. A). In a laminate transformer utilizing an E-I structure, the matching “E” and “I” components are stamped from sheets of thin grain oriented electrical steel, and the sheets are then stacked to create the core. Typically, the primary and secondary windings are wound on bobbins. Multiple bobbins are placed on spindles and spun in order to apply the windings. This method of winding the core with wire supplied on bobbins allows for automation, and so reduces the manufacturing times and also provides insulation between the windings and the core. The E-I core laminations are stacked inside the bobbins to complete the transformer.

In the case of a toroidal core, the core element is typically made from a continuous strip of silicon steel, which is wound like a tight clock spring. The ends are tacked into place with small spot welds, to prevent the coiled steel from unwinding. The core is typically insulated with an epoxy coating or a set of caps or multiple wraps of insulating film, such as MYLAR and/or NOMEX (MYLAR and NOMEX are registered trademarks, reg. no. 0559948 and 86085745, respectively, of the E. I. De Pont de Nemours and Company Corporation, a Delawar Corporation located at 1007 Market Street, Wilmington, Del. 19898). The transformer's windings are applied directly onto the insulated core itself. Additional insulation is required to isolate the windings. Since the windings must be wound through the center hole of the core and the core is one piece, bobbins can't be used on toroidal transformers.

In larger transformers, Distributed Gap cores are often used. Much like a toroid, these cores use a thin strip of silicon steel wound in a square instead of round shape. The shape can be created by winding the steel on a mandrel or by cutting strips to length and bending corners into each cut strip. Each layer of steel in the core has one or two cuts in it. The cuts of each layer are stagger so that they do not form a straight edge. The cuts allow an access path to the center of the core for the placement of wire wound bobbins. The square shape locks each layer's placement in the core so that the position of each cut is maintained. This construction provides a closer approximation of a toroidal core's performance than an EI laminate's. In smaller transformers, the labor needed to assemble a Distributed Gap offsets the advantages, and either an EI laminate core or a toroidal core is used.

As they do not lend themselves to automation, toroidal transformers are more labor intensive to produce. However, the continuous strip of steel used in the core allows the toroidal transformer to be smaller, lighter, more efficient, and quieter than its E-I laminate counterpart. These qualities are highly desirable in many applications and justify the additional expense.

Thus, there is a need for a toroidal transformer that enjoys the advantages of be smaller size, lighter weight, increased efficiency, and quieter operation while overcoming the drawbacks of being labor intensive and more expensive to produce. The present novel technology addresses these needs.

### BRIEF DESCRIPTION OF THE DRAWINGS

For a better understanding of the nature and objects of the present novel technology, reference should be made to the following drawings, in which:

FIG. A is a schematic diagram generally illustrating E-I and toroidal transformer designs of the PRIOR ART.

FIG. 1A is a first perspective view of a toroidal cap segment according to a first embodiment of the present novel technology.

FIG. 1B is a top plan view of FIG. 1A.

FIG. 1C is a second perspective view of FIG. 1A.

FIG. 1D is a third perspective view of FIG. 1A.

FIG. 2A is a first perspective view of a toroidal cap segment according to a second embodiment of the present novel technology.

FIG. 2B is a top plan view of FIG. 2A.

FIG. 2C is a second perspective view of FIG. 2A.

FIG. 2D is a third perspective view of FIG. 2A.

FIG. 3 is a perspective view of a toroidal cap segment according to a third embodiment of the present novel technology.

FIG. 4 is a perspective view of a toroidal cap segment according to a fourth embodiment of the present novel technology.

FIG. 5A is a top perspective view of a plurality of segments forming a toroidal core cap ring according to a fifth embodiment of the present novel technology.

FIG. 5B is a bottom perspective view of FIG. 5B.

FIG. 6A is a top perspective view of a plurality of segments forming a toroidal core cap ring according to a sixth embodiment of the present novel technology.

FIG. 6B is a bottom perspective view of FIG. 6B.

FIG. 7 A is a bottom perspective view of a winding tool according to a seventh embodiment of the present novel technology.

FIG. 7B is a perspective view of a wire lock tool for use with FIG. 7A.

FIG. 8A is a perspective view of a partially wound core using the present novel technology.

FIG. 8B is another perspective view of another partially wound core.

FIG. 9 is a perspective view of a toroidal transformer including the segmented core caps of the present novel technology.

FIG. 10A is a perspective view of an eighth embodiment of the present novel technology.

FIG. 10B is a second perspective view of FIG. 10A.

FIG. 11A is a top plan view of a ninth embodiment of the present novel technology.

FIG. 11B is a bottom plan view of FIG. 11A.

FIG. 11C is a perspective view of FIG. 11A.

FIG. 12 is a partial perspective cutaway view of a segmented core system according to a tenth embodiment of the present novel technology.

FIG. 13 is a schematic view of the plurality of cut laminations with holes punched near the ends of the layers.

FIG. 14 is an elevational view of one embodiment of the core.

FIG. 15 is a partial enlarged view of a portion of the core.

FIG. 16 is a view of the two halves of the embodiment of the core separated.

FIG. 17 is an enlarged view of the end of a core segment showing elongated fingers and gaps therebetween.

FIG. 18 is a partial enlarged view of the joint between the core segments showing interlocking fingers.

FIG. 19 is a sectional view showing the core incorporated into a toroidal type transformer.

FIG. 20A-D are views of a semicircular core segment with wound bobbins positioned thereover.

### DETAILED DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

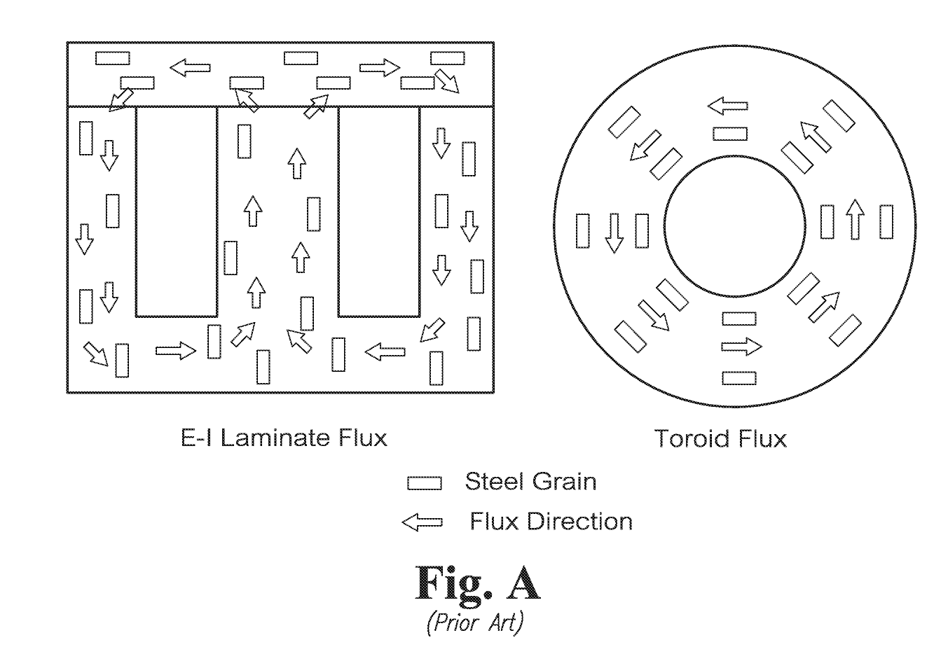

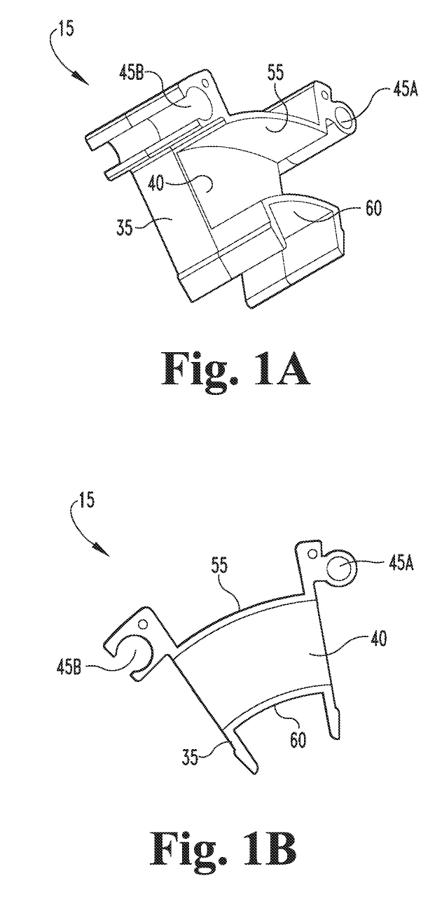

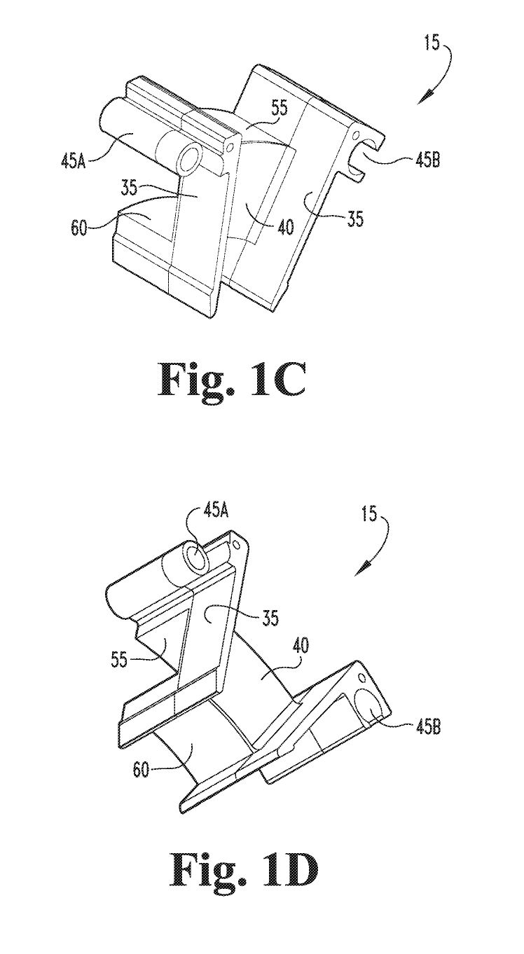

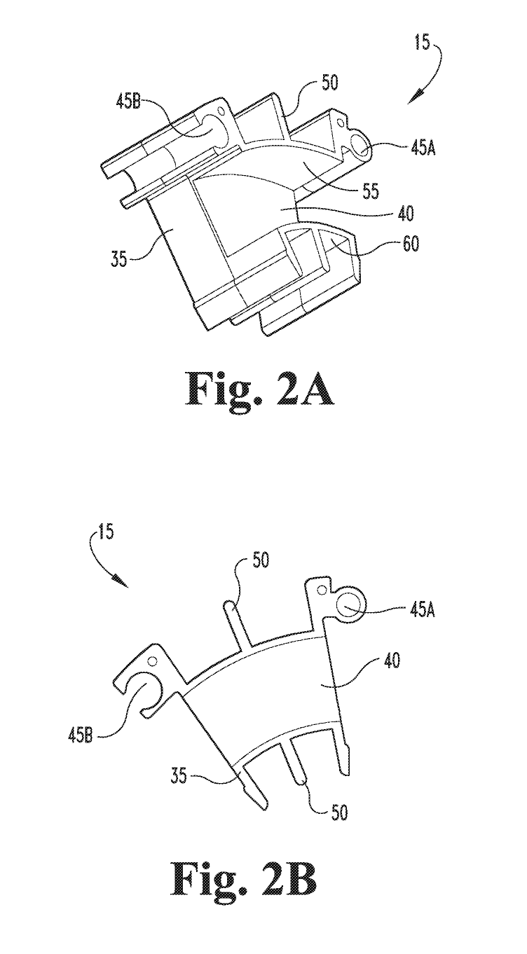

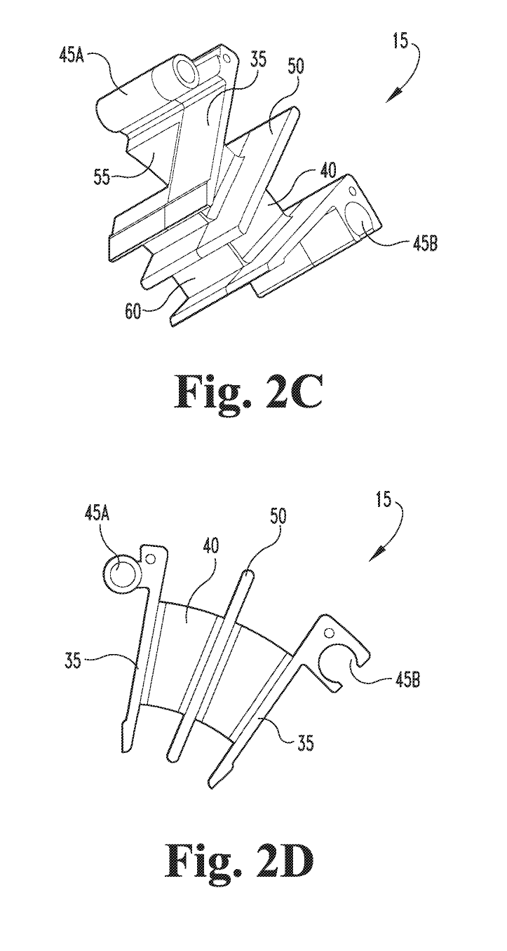

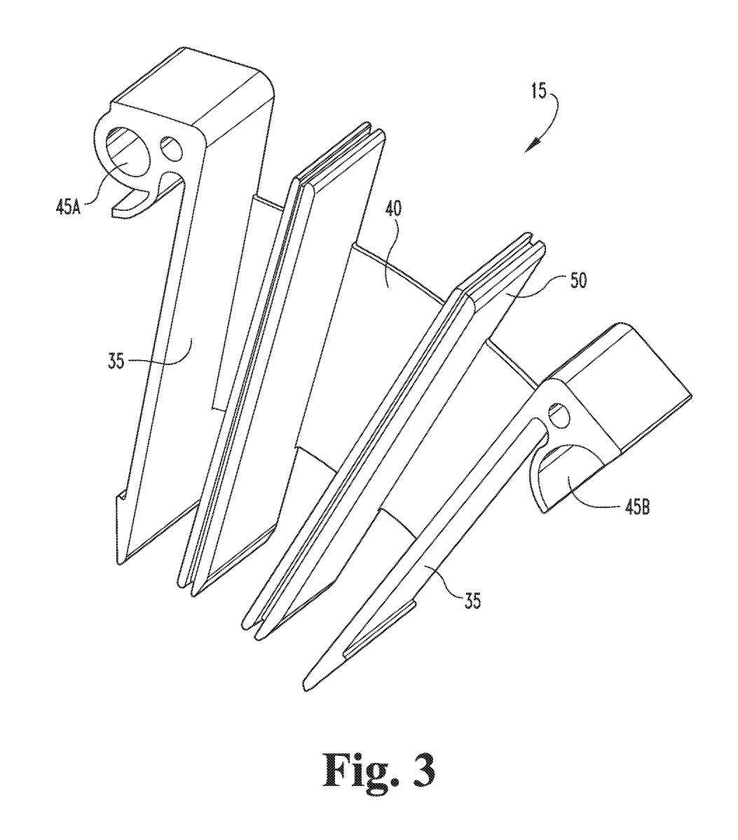

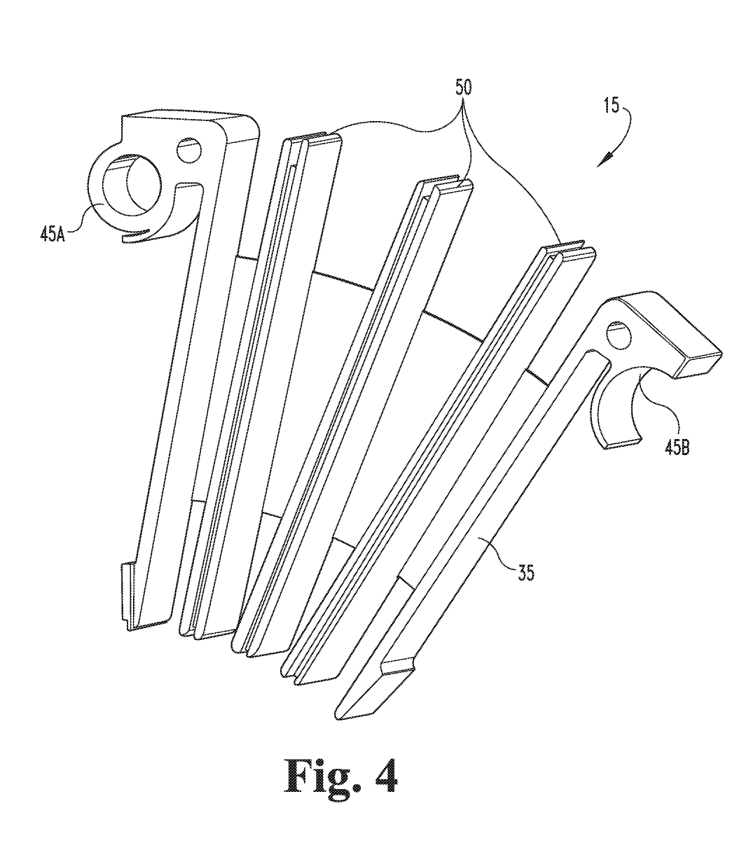

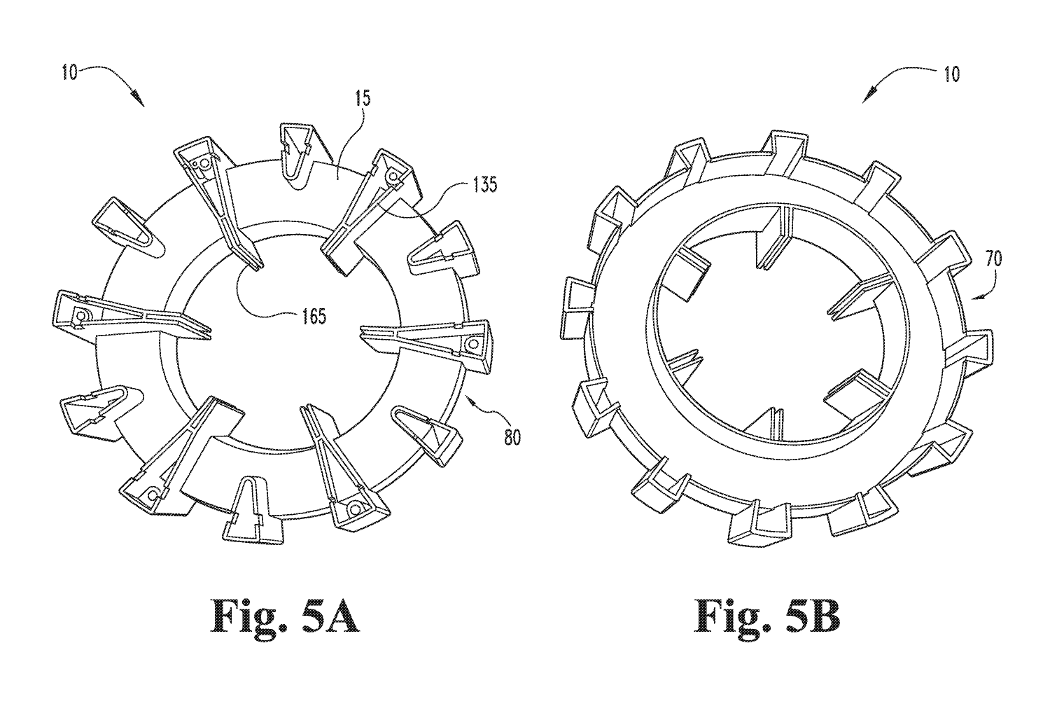

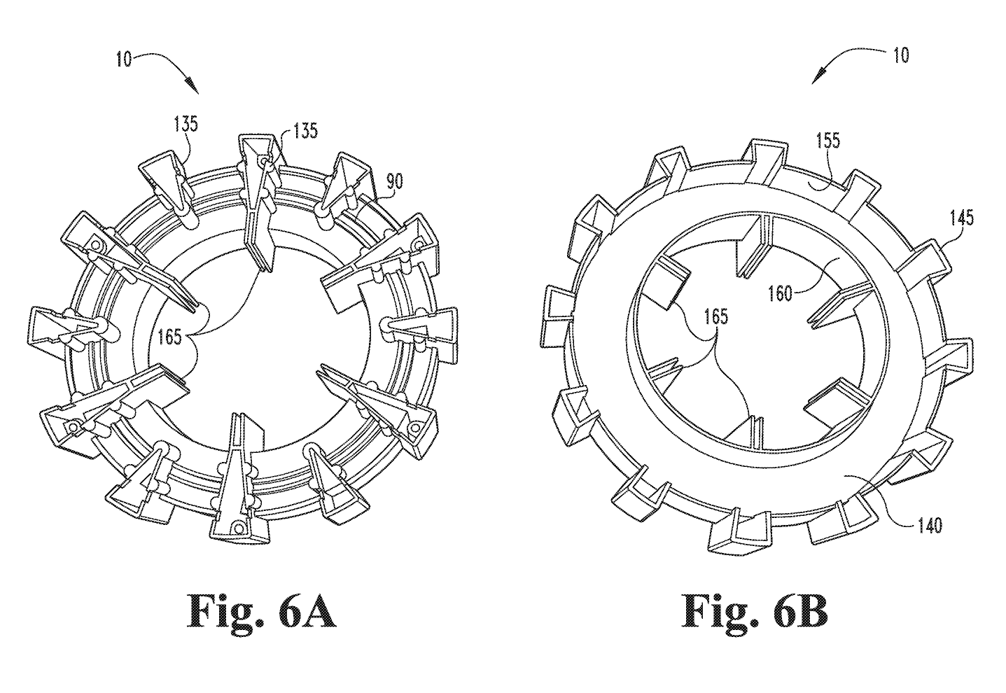

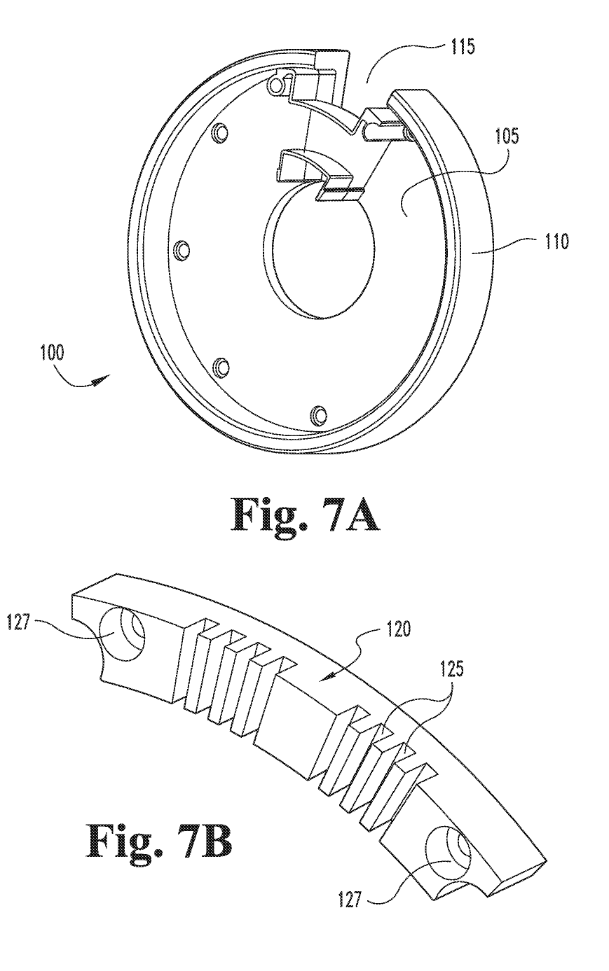

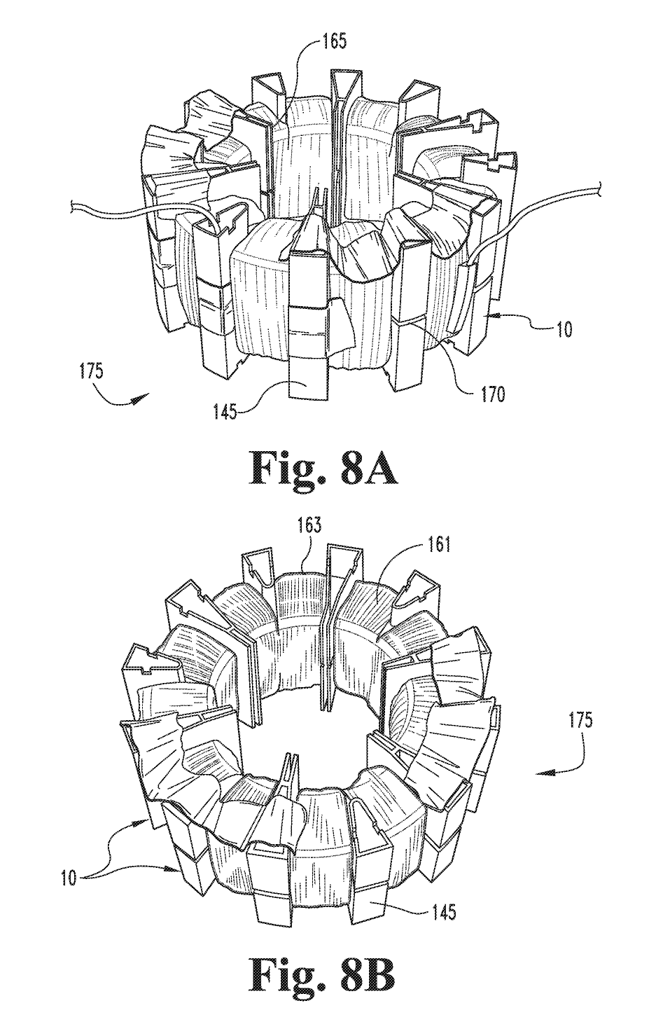

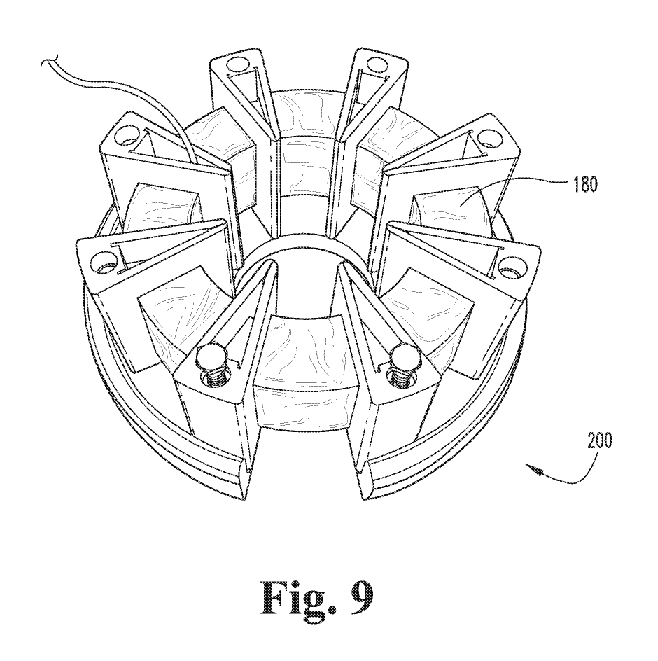

Embodiments of the present novel technology are illustrated in FIGS. 1-11B, and relate to segmented or modular electrically insulating core caps 10 for supporting primary and secondary windings, typically in alternate sectors, to reduce leakage current. Pluralities of individual modular electrically insulating segments 15 typically snap, or otherwise join, together to define annular or semi-annular modular core caps 10 for covering or partially covering a (typically steel) ring-type toroidal transformer core 20. The segments or modules 15 are typically made from an insulating material, such as nylon, ZYTEL, or the like (ZYTEL is a registered trademark, reg. no. 71666270, of the E.I. Du Pont De Nemours and Company Corporation, 1007 Market Street, Wilmington, Del. 19898).

The core cap modules 15/completed core caps 10 insulate windings from the core 20 over the full range of the windings, and allow for double wall insulation between adjacent windings, significantly reducing leakage current over the prior art systems. The core cap modules 15/completed core caps 10 also provide for direct cooling of the core 20 by ambient or forced air without intervening insulation. The core 20 may be assembled from component modules 15 over a completed, wound toroidal core 20. The core caps 10 allow for winding 25 of the transformer 30 using standard winding equipment while maintaining a direct path for waste heat to escape, as there is no need for interwinding insulation that can trap heat. Further, the core caps 10 eliminate the need for center fill epoxy and/or mounting washers, so the weight of the transformer 30 is reduced.

In most embodiments, the segments 15 each include a pair of spaced, typically electrically insulating, wall members 35 between which a core covering panel portion 40 is connected. The wall members 35 are disposed at a predetermined angle relative to each other, typically 30 degrees, 45 degrees, 60 degrees, or the like so that each modular segment 15 spans an arc of about 30 degrees, 45 degrees, 60 degrees or the like. The respective spaced walls 35 include removably engagable, typically male and a female, connector portions 45A, 45B, respectively, such that adjacently disposed segments 15 may be repeatedly removably engaged with one another, with sufficient connected segment portions 15 defining an annular core cap 10. The number of segments 15 required to complete a core cap 10 is predetermined and is typically a function of the predetermined angle between the wall s 35; for example, if the angle is 45 degrees, eight segments 15 will be required to be connected together to define a ring 10. If the angle is sixty degrees, only six segments 15 will be required to define a ring 10. While core caps 10 are typically built from identical core cap modules 15 core caps 10 may alternately include combinations of core cap modules 15 spanning different arcs, such as four core cap modules 15 spanning forty-five degrees each and six core cap modules 15 spanning thirty degrees each. While identically sized and shaped modules 15 are typically more convenient, there are no practical restrictions on the combinations of core cap module 15 sizes and shapes that may be combined to yield a custom core cap 10 having desired properties and characteristics.

Typically, the wall s 35 engage the panel 40 to define a relatively flat or flush core-engaging side or surface (defining the bottom or underside 70 of the segment 35 and ring 10, located in the downward direction) and disposed opposite the barriers 75 established by two joined or locked together wall s 35 (defining by the wire-segmenting or topside 80 of the ring 10, located in the upward direction). The barriers 75 define the parameters between which alternating wire windings are restricted, typically alternating primary and secondary windings.

In some embodiments, the segments 15 include one or more separation or wall members 50 positioned to partially or completely extend across the topside 75 of the panel 40 to further define parameters between which wire windings are directed. The one or more separation members 50 are typically positioned equidistantly between the wall s 35 and/or each other 50, respectively. The one or more separation members 50 are typically oriented to extend radially outwardly from the center of the core 20 and/or the annulus 10 defined by the joined segments 15; in other words, each respective separation member 50 typically lies on a radius of the annulus 10, although the separation walls 50 may have other convenient shapes and contours as desired.

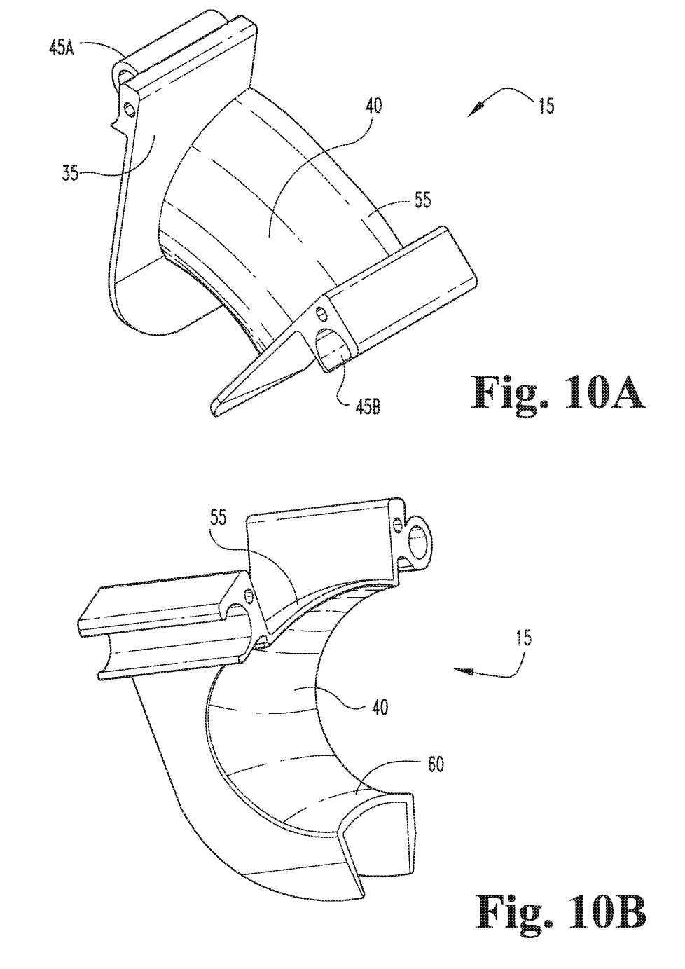

In some embodiments, the segments 35 further include a core outer diameter or OD cover panel 55 and/or a core inner diameter or ID cover panel 60, both extending downwardly so as to at least partially cover the OD and ID, respectively, of a toroidal core ring placed against the core cover panels 40 of a partially or completely formed annulus 10. These panels 55, 60 may be flat for covering a core ring 20 having flat outer and inner diameter sides, or curved to follow a core ring 20 having a rounded or curved inner and outer diameter portions (see FIGS. 10A-B)

In some embodiments, the wall members 35 are truncated and do not extend across the panels 40. In some of these embodiments, lower wall members 65 are positioned opposite the panel 40 from the respective wall members 35. The lower wall members 65 may likewise include matable connectors for co-joining.

In some embodiments, the segments 35 include ribs positioned on the upper side of the panels 40, so as to generate an air gap between wire windings and the topside 80 of the ring 10. The production of an air gap facilitates air cooling of windings by allowing air to circulate between windings and the topside 80 of the cap 10.

In some embodiments, a winding tool 100 is included to facilitate the winding of a capped core from a single bobbin. The winding tool 100 is typically a flat ring 105 having a projecting rim or flange 110 extending from the outer diameter thereof. The ring 100 typically includes a slot 115 formed there through, such that the ring 110 has a C-shape. The ring 110 is sized to accept a segment 15 therein, with the slot 115 sized to pass wire onto a segment 15 aligned therewith. Winding tool 100 further typically includes an elongated arced wire lock member 120 having a plurality of slots 125 formed partially therethrough and one or more locking apertures 127 formed therethrough for connecting the wire lock member 120 to one or more segments 15 during the wire winding process.

In operation, a plurality of segments 15 may be connected to one another to define a ring 10. The ring 10 includes an annular core top cover portion 140 defined by the panels 40 of the individual segments 15. In most embodiments, the ring 10 also includes (typically) equidistantly spaced radial protrusions 145, defined by mutually engaged connectors 45A, B, extending outwardly from the ring 10. Each radial protrusion 145 is typically part of an elongated wall member 135 positioned on the topside 80 of the ring 10 and extending radially inwardly partway or completely across the topside surface 80. Some of the wall s 135 terminate in radial protrusions 165 extending inwardly from the ring 10. These radial protrusions 165 are typically formed from the joinder of two lower wall s 65, although they may be formed separately.

The ring 10 may also include an annular core outer diameter cover member 155 and/or an annular core inner diameter cover member 160, each cover member 155, 160 positioned generally perpendicular to the core top cover portion 140 and extending downwardly away therefrom. The respective cover members 155, 160 are typically composed of adjacent cover panels 55, 60 when the segments 15 are connected to define the ring 10.

Typically, a pair of cap rings 10 are constructed from connected segments 15 and positioned on opposite sides of a toroidal core 20 with outward protrusions 145 aligned. Typically, an even number of segments 15 are connected to make each ring 10. Wire is wound contiguously around alternating segments 15 to define the primary windings 161, with N windings per segment 15. Wire is wound contiguously around the remaining segments 15, in multiples of N windings per segment 15, to define the secondary windings 163. Typically, all of the windings 161, 163 may be accomplished from a single bobbin or shuttle in one contiguous bobbin winding 25 operation, with wire guided from one segment 15 to the next through the groove or gap 170 between the two opposite core caps 10. The wire is typically cut or severed to isolate the primary windings 161 from the secondary windings 163, and the wound core 175 may then be wrapped in insulation 180 to define a toroidal transformer 200. In some embodiments, the winding tool 100 may be utilized to facilitate core winding. Coils 20 so wound retain the advantages of toroidal transformers while enjoying the benefits of being lighter, smaller, more efficient and quieter than E-I laminate cores. Cores 20 so wound exhibit reduced interwinding leakage current when compared with standard wound toroidal transformer cores.

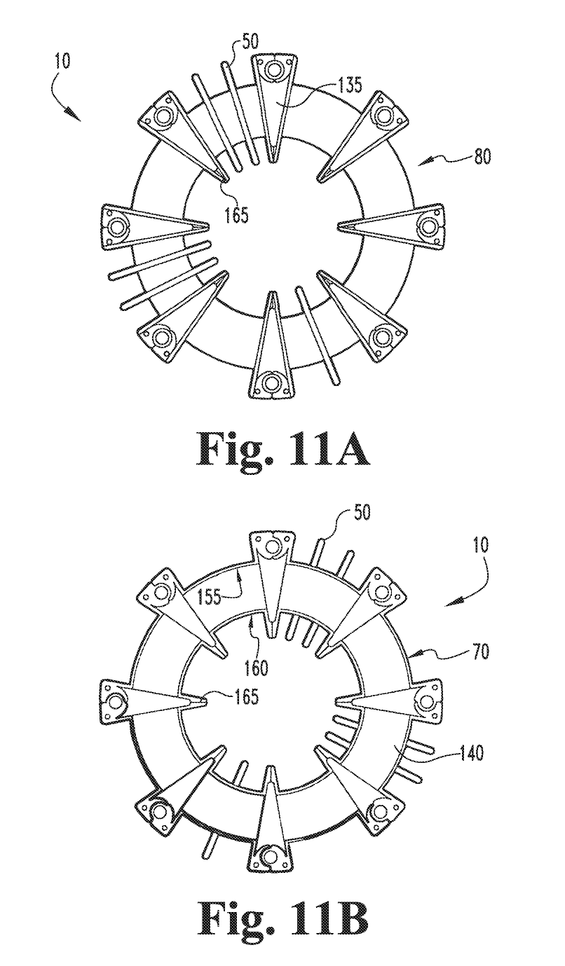

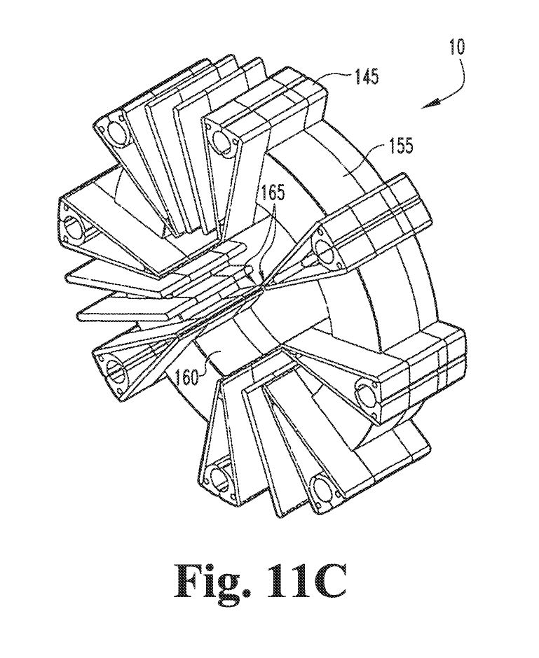

Typically, the primary windings 161 will occupy the odd numbered segments 15, starting with the first segment wound, and the secondary windings 163 will occupy the even numbered segments 15. In some embodiments, each ring 10 may contain multiples of three segments 15, such as six, nine, or twelve, and the core 20 may be wound with primary 161, secondary 163 and tertiary (not shown) windings as above to yield a three-phase transformer. In other embodiments, the ring may contain segments 15 having different configurations (see FIGS. 11A-11C).

In some embodiments, an insulating material, such as a MYLAR strip, is positioned to cover the portion of the core 20 exposed by the gap 170. In other embodiments, the core 20 is partially or completely wrapped in an insulating material prior to the positioning of the cap(s) 10 thereupon. In still other embodiments, wall members 35 are spaced and oriented relative each other to define an annulus, but are not physically connected to each other. In most embodiments, the wire wrapping the core 20 is sheathed in an insulating layer or film.

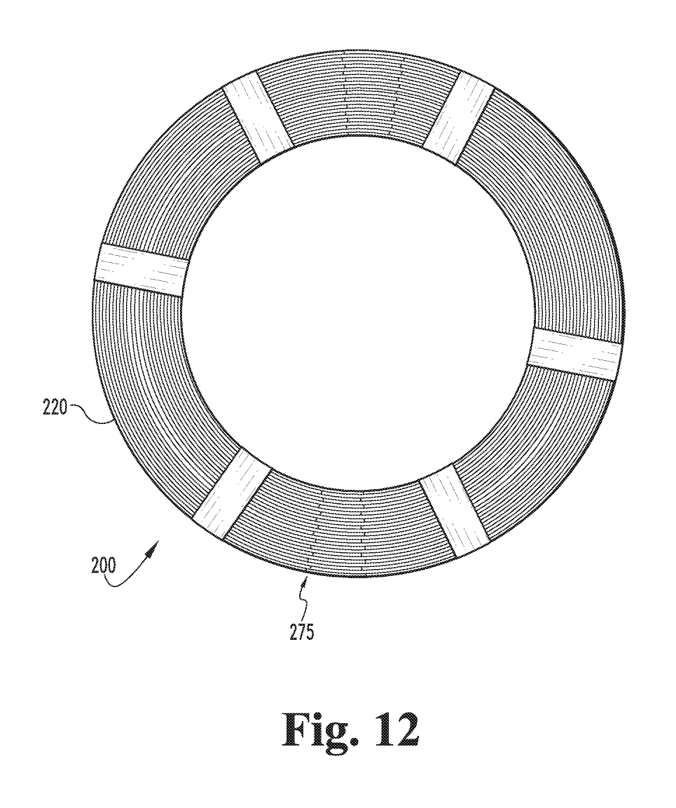

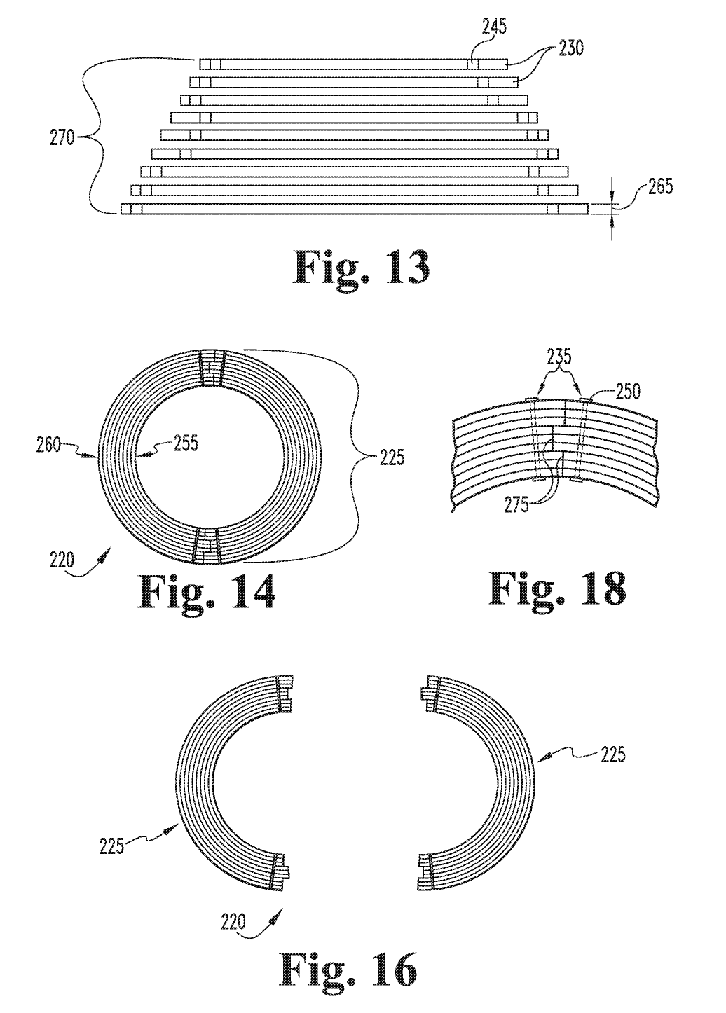

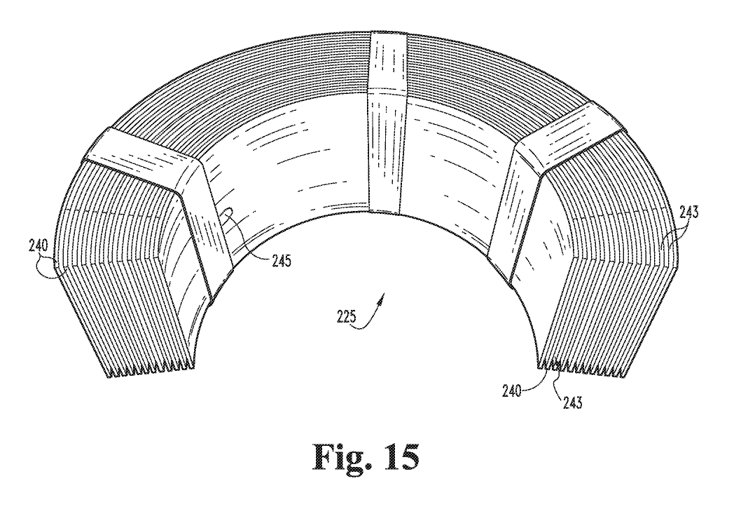

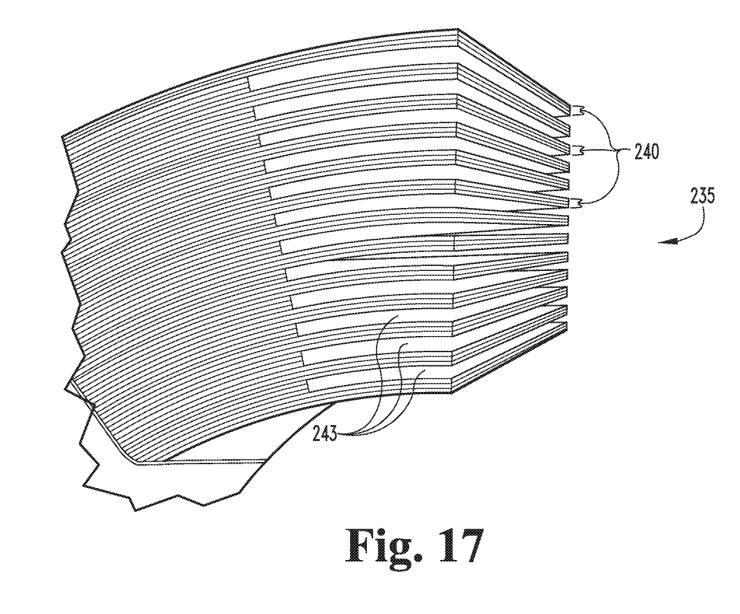

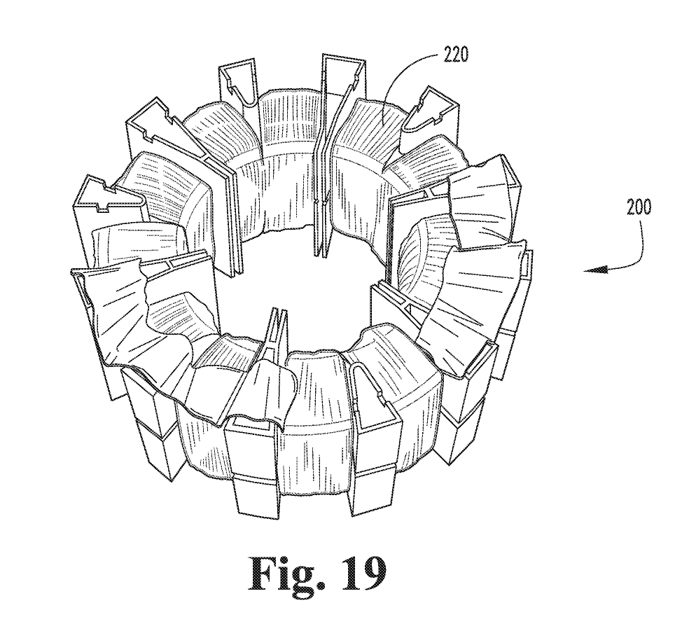

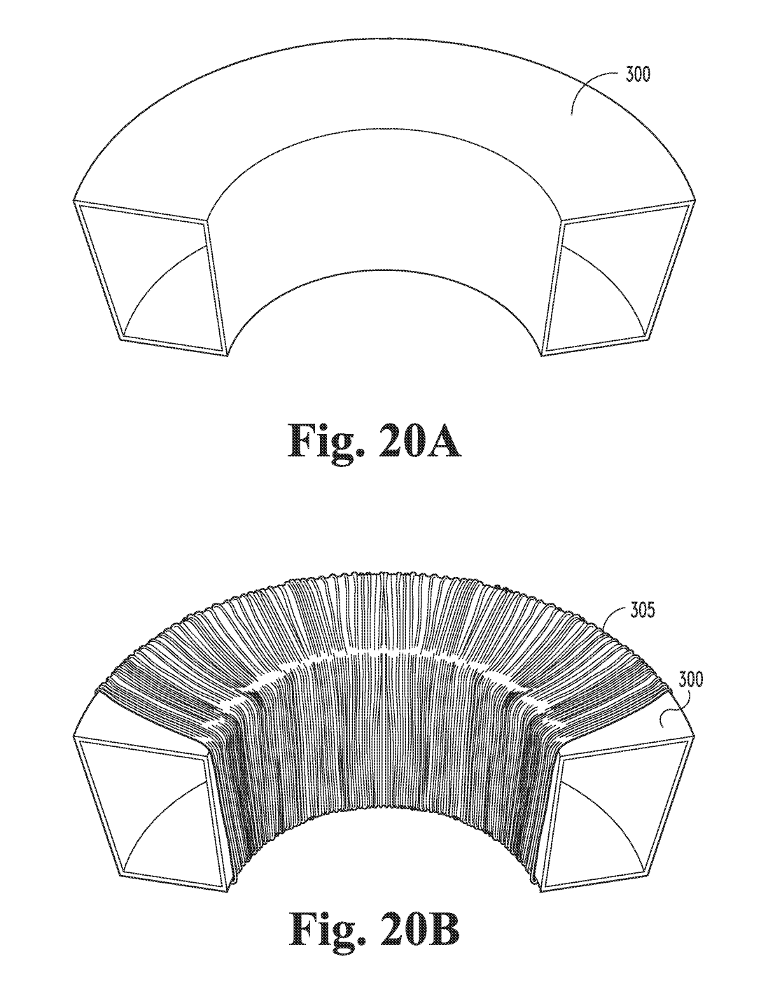

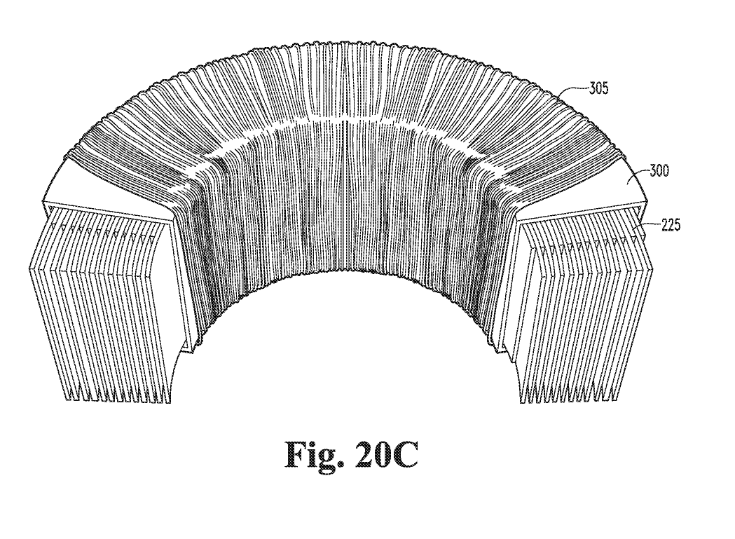

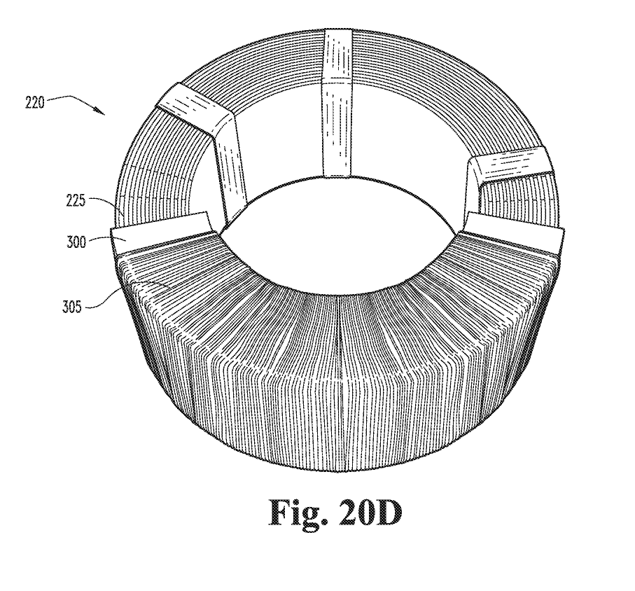

FIGS. 12-20D illustrate a tenth embodiment of the novel technology, a segmented core system 200 for a toroidal transformer, each core 220 formed from core segments 225 built by layering curved or curvable metallic strips 230 to define the respective core segments 225. The metallic strips 230 are typically steel, but may be formed from other metals or alloys having desirable physical, material, and magnetic properties.

Typically, each toroidal transformer core 220 is formed from two semicircular segments 225, although other configurations (such as three 60-degree segments 225) could be built to yield a core 220. Each segment 225 is formed by layering a plurality of steel strips 230 to yield a core segment 225 of predetermined diameter, and when curved yield a (typically) semicircular core segment 225 having a predetermined desired ID and OD. The joining ends 235 typically do not define or form a continuous flat surface, but rather alternating extended and recessed strips (or several strips defining layers or fingers 240) that matingly engage or interlock with recesses 243 defined between the extended strips or fingers 240 of the second, mating segment 225 to yield a circular core 220, with nonaligned end gaps 275. The steel strips 230 include holes or apertures 245 formed through or located at either end that may be aligned, when curved into a segment 225, and secured by a fastener 250, such as a pin or like member, extending therethrough.

By this method of creating the toroidal core 220, the core's inside diameter 255, outside diameter 260, and the steel strip's thickness 265 may be used to determine the length of each layer 230 of steel in the core 220. Each layer 230 is typically produced by cutting a steel strip into two equal length pieces 230, each strip 230 having the required length for that core segment layer 230. Both steel strips of each layer 235 have a hole or aperture 245 punched or otherwise formed therethrough and positioned near each end. The holes 245 are positioned so that when the layers 235 are stacked and curved to form the desired ID 255 and OD 260, the holes 245 align for each segment 225 of the core 220 such that the joining half edges 235 are not flush, but instead alternate with protruding and recessed strips 230 that matingly engage the recessed and protruding portions 240 of the strips 230 of the other core half 220. Alternately, steel strips 230 of predetermined lengths, with apertures 245 formed therethrough at predetermined locations, may be produced by any convenient means.

When each core segment 225 is completed as defined by the desired total thicknesses of the stacked layers 230, the steel strips 230 are typically annealed to relieve stress. After annealing, the steel strips 230 are stacked in order to define the core segment 225, the holes 245 at either end are aligned, and a fastener 250 is engaged to hold the stacked strips 230 together. Typically, a respective pin 250 is placed through each of the respective aligned holes 245 at each respective end 235 to bind the strips 230 together to define a segment 225. In particular, after the first pin 250 is inserted through the aligned apertures 245 at a first end 250, the stack 270 is tensioned or bent until the curvature of the inside diameter 255 is achieved. The holes 245 at the opposite end 235 of the strips 230 will then likewise be aligned and a second pin 250 is placed therethrough. With both ends 235 pinned, the so-produced core half 225 maintains its desired (typically semicircular) shape. The subsequent core segments 225 are then made in the same manner.

The two halves 225 of the core 220 can be matingly joined together to define and form a toroidal core 220 with distributed gaps 275. Since the gaps 275 in each layer 230 do not overlap, the properties of the assembled core 220 are nearly identical to a traditionally wound core. The core 220 at this point could be bound together with a layer of steel around the outside and wound as a typical toroidal, if desired. However, there is little practical advantage in doing so, as it is unlikely that there would be any cost saving in the core manufacturing and the time necessary to make the final transformer would be the same.

In the above example, the core segments 225 are envisioned as halves, each segment 225 spanning 180 degrees. In other embodiments, the matable semicircular core segments 225 may be core thirds, each spanning 120 degrees, core quarters, each spanning 90 degrees, or the like.

One clear advantage of making the core 220 in semicircular segments 225, typically two halves 225, is the primary and secondary winding can be wound on bobbins separately and then positioned over the core 220. The bobbins, however, are typically not the traditional square bobbins, and instead typically would be made in semicircular segments as described above. Each half 225 of the core 220 would have its bobbins slid over the core, and the two halves brought together, with the bobbins interlocking to bind the core halves 225 in place. One advantage of this method over the traditional distributed gap core transformers is the primary and secondary windings cover the entire core and not just two legs or portions thereof, yielding increased efficiency as most of the core flux is coupled to the winding and not lost to the surroundings.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A modular toroidal transformer core system, comprising:
a plurality of matable semicircular core segments, wherein each respective matable semicircular core segment further comprises:
a plurality of steel layers defining a semicircular core segment having a first end and a second end;
a plurality of alternating fingers extending from each end and defining alternating gaps therebetween, wherein each respective finger is at least one layer thick and wherein each respective gap has the same thickness as a respective finger;
a first generally cylindrical aperture extending through each respective core segment adjacent each respective first end; and
a second generally cylindrical aperture extending through each respective core segment each respective second end; and
a plurality of fasteners, each respective fastener extending through each respective aperture to hold each respective matable semicircular core segment together;
wherein the respective matable semicircular core segments are engagable with one another to define an annular core having distributed, nonoverlapping gaps.

2. The modular toroidal transformer core system of claim 1 wherein each matable semicircular core segment spans 180 degrees and wherein two core segments are matable to define an annular core.

3. The modular toroidal transformer core system of claim 1 wherein each matable semicircular core segment spans 120 degrees and wherein three core segments are matable to define an annular core.

4. The modular toroidal transformer core system of claim 1 wherein each matable semicircular core segment spans 90 degrees and wherein four core segments are matable to define an annular core.

5. The modular toroidal transformer core system of claim 1 and further comprising a plurality of semicircular bobbins, wherein each respective bobbin envelopes a respective semicircular core segment; wherein the respective bobbins interlock to hold the respective semicircular core segments in place; and wherein each bobbin is wound with wire windings.

6. A modular toroidal transformer core assembly, comprising:
a plurality of interconnected semicircular core segments defining an annular core, wherein each respective semicircular core segment further comprises:
a plurality of curved steel layers defining a semicircular core segment having a first end and a second end;
a plurality of fingers extending from each end;
a plurality of gaps extending from each end, wherein each respective gap lies between and is defined by two respective fingers;
wherein each respective finger defines a predetermined number of layers;
a plurality of apertures, each respective aperture extending through a respective semicircular core segment adjacent each respective end; and
a plurality of fasteners, each respective fastener extending through each respective aperture to hold each respective semicircular core segment together;
wherein each respective semicircular core segments is interlockingly engaged with another respective semicircular core segment to define the annular core.

7. A method for assembling a toroidal transformer core, comprising:
a) stacking a first plurality of elongated steel strips to define a first core portion;
b) tensioning the first core portion to yield a first semicircular core segment having a first plurality of spaced fingers extending from a first end and a second plurality of spaced fingers extending from a second, opposite end;
c) stacking a second plurality of elongated steel strips to define a second core portion;
d) tensioning the second core portion to yield a second semicircular core segment having a third plurality of spaced fingers extending from a third end and a fourth plurality of spaced fingers extending from a fourth, opposite end; and
e) interlocking the fingers extending from the first semicircular core segment with the fingers extending from the second semicircular core segment to yield a toroidal transformer core.

8. The method of claim 7 and further comprising operationally connecting fasteners to each respective core segment to hold the stacked steel strips together.

9. The method of claim 7 and further comprising the step of f) annealing each respective semicircular core segment.

10. The method of claim 7 and further comprising:
g) winding a plurality of semicircular bobbins with primary windings to yield a plurality of wound bobbins; and
h) enveloping each respective semicircular core segment with a respective wound bobbin.

11. The method of claim 10, wherein each respective wound bobbin is further wound with a respective secondary winding.

12. The method of claim 10 and further comprising i) lockingly engaging the bobbins together to define an annular core.
